(19) United States
(12) Patent Application Publication
(10) Pub. No.: US 2025/0020850 A1
(43) Pub. Date: Jan. 16, 2025

(54) WAVEGUIDE, DISPLAY DEVICE, METHOD, AND APPARATUS

(71) Applicant: DISPELIX OY, Espoo (FI)

(72) Inventor: Tommi KAPLAS, Kulho (FI)

(73) Assignee: DISPELIX OY, Espoo (FI)

(21) Appl. No.: 18/708,579

(22) PCT Filed: Oct. 27, 2022
(86) PCT No.: PCT/FI2022/050706

§ 371 Date: May 8, 2024

(30) Foreign Application Priority Data
Nov. 11, 2021 (FI) 20216158

(51) Int. Cl. F21V 8/00; G02B 5/18; G02B 27/01

(52) U.S. Cl. CPC G02B 6/0035; G02B 5/1814; G02B 6/0065; G02B 27/0172

(57) ABSTRACT

A waveguide (1000) configured to propagate light (1001) by total internal reflection, a display device, as well as a method and an apparatus for forming a waveguide are disclosed. The waveguide (1000) comprises a waveguide body (1100) comprising a first face (1110) and a second face (1120) opposite the first face (1110); and a coating (1200) on the first face (1110), the coating (1200) comprising an outer surface (1210) facing away from the first face (1110). The first face (1110) comprises a curved interface region (1111) between the waveguide body (1100) and the coating (1200), and the outer surface (1210) comprises a curved outer region (1211) opposite the interface region (1111). The outer region (1211) comprises a patterned region (1212), and the coating (1200) comprises on the outer surface (1210) a surface relief structure (1220) defining the patterned region (1212).

### FIELD OF TECHNOLOGY

This disclosure concerns display devices and waveguides therefor. In particular, this disclosure concerns curved waveguides, display devices comprising such waveguides, as well as methods and apparatuses for forming such waveguides.

### BACKGROUND

Comfort of use and a small form factor are essential for various portable display devices, especially head-mounted see-through display devices, such as waveguide-based smart glasses. In case of such smart glasses, improved comfort and a reduced form factor could be attained by utilization of curved waveguides instead of flat waveguides for directing images to the user's eye(s).

In waveguide-based display devices, optical in-couplers, out-couplers, and exit pupil expanders may be preferably formed using surface-relief gratings (SRGs). Compared to other types of diffraction gratings, SRGs offer increased versatility, the properties of SRGs being adjustable by tuning a multitude of selectable structural parameters.

In industrial-scale manufacturing, SRGs are conventionally fabricated using nanoimprint lithography (NIL). In NIL, a mold comprising an inverse of the desired pattern is pressed onto a resist-coated substrate to imprint the pattern into the resist. However, conventional NIL fabrication methods of waveguides sufficiently rigid for use in portable display devices necessitate the usage of a flat substrate for forming a waveguide body.

In light of the above, it may be desirable to develop new solutions related to fabrication of portable display devices comprising curved waveguides.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to a first aspect, a waveguide is provided. The waveguide is configured to propagate light coupled into the waveguide by total internal reflection. The waveguide comprises a waveguide body comprising a first face and a second face opposite the first face and a coating on the first face, the coating comprising an outer surface facing away from the first face. The first face comprises a curved interface region between the waveguide body and the coating. The outer surface comprises a curved outer region opposite the interface region. The outer region comprises a patterned region. The coating comprises on the outer surface a surface-relief structure defining the patterned region.

In an embodiment of the first aspect, the waveguide is obtainable by a method in accordance with the third aspect and/or by an apparatus in accordance with the fourth aspect.

According to a second aspect, a display device comprising a waveguide in accordance with the first aspect is provided.

According to a third aspect, a method for forming a waveguide is provided. The method comprises providing a mold comprising a contact surface patterned with a surface-relief pattern; providing a substrate comprising a first surface comprising a curved surface region; forming a patternable film on the first surface, the patternable film comprising an external surface facing away from the surface region; rotating the substrate such that the external surface rolls over the contact surface to imprint the surface-relief pattern from the contact surface into the patternable film to form a patterned film; and cutting the substrate to form the waveguide.

In an embodiment of the third aspect, the waveguide is a waveguide in accordance with the first aspect or any embodiment thereof.

It is specifically to be understood that methods according to the third aspect may be used to provide waveguides according to the first aspect or any embodiment(s) described in relation to the first aspect.

According to a fourth aspect, an apparatus for forming a waveguide is provided. The apparatus comprises a mold holder arrangement configured to hold a mold comprising a contact surface patterned with a surface-relief pattern; a substrate holder arrangement configured to hold a substrate comprising a first surface comprising a curved surface region; a film formation arrangement configured to form a patternable film on the first surface, the patternable film comprising an external surface facing away from the surface region; and a substrate cutting arrangement configured to cut the substrate to form the waveguide. The substrate holder arrangement is configured to rotate the substrate such that the external surface rolls over the contact surface to imprint the surface-relief pattern from the contact surface into the patternable film to form a patterned film.

In an embodiment of the fourth aspect, the apparatus comprises means adapted to carry out a method in accordance with the third aspect or any embodiment thereof.

It is specifically to be understood that apparatuses according to the fourth aspect may be used to provide waveguides according to the first aspect or any embodiment(s) described in relation to the first aspect.

### BRIEF DESCRIPTION OF THE DRAWINGS

The present disclosure will be better understood from the following detailed description read in light of the accompanying drawings, wherein:

FIGS. 1, 2, 3, and 4 depict waveguides;

FIGS. 5 and 6 show a display device and a waveguide thereof, respectively;

FIG. 7 illustrates a method for forming a waveguide;

FIG. 8 depicts an apparatus for forming a waveguide;

FIG. 9 shows another apparatus for forming a waveguide;

FIG. 10 depicts a substrate cutting arrangement; and

FIG. 11 depicts a substrate.

Unless specifically stated to the contrary, any drawing of the aforementioned drawings may be not drawn to scale such that any element in said drawing may be drawn with inaccurate proportions with respect to other elements in said drawing in order to emphasize certain structural aspects of the embodiment of said drawing.

Moreover, corresponding elements in the embodiments of any two drawings of the aforementioned drawings may be disproportionate to each other in said two drawings in order to emphasize certain structural aspects of the embodiments of said two drawings.

### DETAILED DESCRIPTION

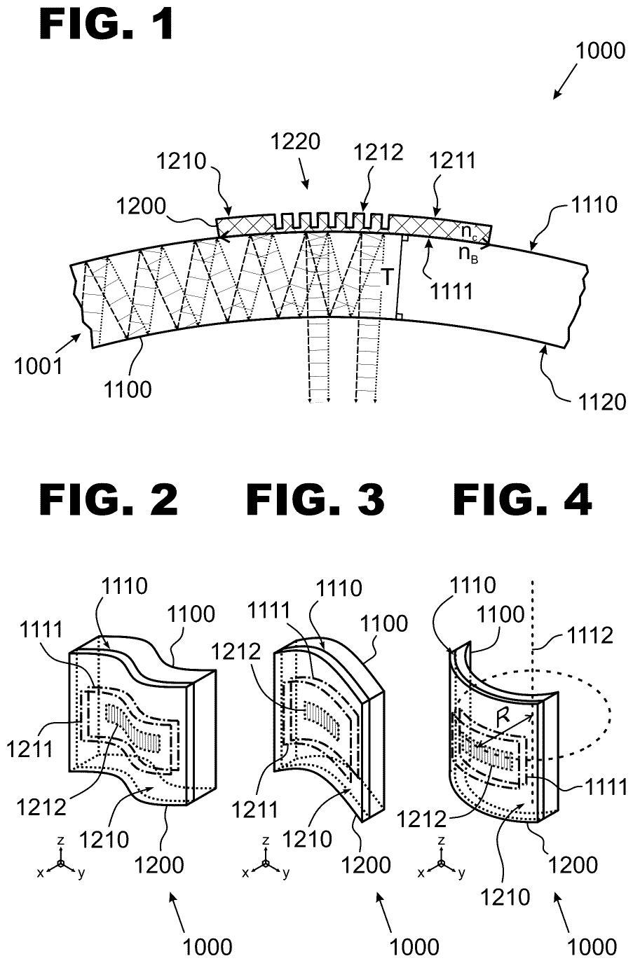

FIG. 1 depicts a waveguide 1000 according to an embodiment. The waveguide 1000 is configured to propagate light 1001 coupled into the waveguide 1000 by total internal reflection.

In this disclosure, a “waveguide” may refer to an optical waveguide. Additionally or alternatively, a waveguide may refer to a two-dimensional waveguide, wherein light may be confined along a thickness direction of said waveguide. In case of a curved waveguide, such thickness direction may be position dependent.

In the embodiment of FIG. 1, the waveguide 1000 comprises a waveguide body 1100. The waveguide body 1100 comprises a first face 1110 and a second face 1120 opposite the first face 1110.

The waveguide 1000 of the embodiment of FIG. 1 further comprises a coating 1200 on the first face 1110. The coating 1200 comprises an outer surface 1210 facing away from the first face 1110.

In the embodiment of FIG. 1, the first face 1110 comprises a curved interface region 1111 between the waveguide body 1100 and the coating 1200.

Throughout this specification, a “region” may refer to at least part of a surface or a face. Further, an “interface region” may refer to a region of a first face of a waveguide body extending at an interface of said waveguide body and a coating arranged onto said waveguide body. Generally, an interface region may or may not be curved throughout the entire extent thereof.

The outer surface 1210 of the embodiment of FIG. 1 comprises a curved outer region 1211 opposite the interface region 1111.

In this disclosure, an “outer region” may refer to a region of an outer surface of a coating opposite an interface region of a first face of a waveguide body. Additionally or alternatively, an outer region may refer to a region of an outer surface of a coating having a projection onto a first face of a waveguide body at least partly, i.e., partly or entirely, overlapping an interface region of said first face.

In the embodiment of FIG. 1, the outer region 1211 comprises a patterned region 1212, the coating 1200 comprising a surface-relief structure 1220 defining the patterned region 1212 on the outer surface 1210. Generally, a coating of a waveguide comprising a surface-relief structure on a curved outer surface of said coating may increase comfort of use and reduce the form factor of a waveguide-based display device comprising said waveguide.

Throughout this specification, a “patterned region” may refer to at least part of a curved outer region of an outer surface of a coating, i.e., said outer region or a part thereof, said patterned region defined by boundaries of a surface-relief structure formed in said coating.

In the embodiment of FIG. 1, the surface-relief structure 1220 comprises a diffractive optical element. In other embodiments, a surface-relief structure may or may not comprise, consist essentially of, or consist of a diffractive optical element, such as a diffraction grating.

Herein, a “diffractive optical element”, may refer to an optical element the operation of which is based on diffraction of light. Generally, a diffractive optical element may comprise structural features with at least one dimension of the order of the wavelengths of visible light, for example, at least one dimension less than one micrometer. Typical examples of diffractive optical elements comprise one- and two-dimensional diffraction gratings, which may be implemented as single-region diffraction gratings or as multi-region diffraction gratings. Diffraction gratings may generally be implemented, at least, as surface relief gratings (SRGs) or volume holographic gratings (VHGs), and they may be configured to function as transmission- and/or reflection-type diffraction gratings.

In the embodiment of FIG. 1, the waveguide body 1100 may have a thickness (T), measured from the interface region 1111 to the second face 1120, of approximately 0.3 millimeters (mm). Generally, a higher thickness of a waveguide body of a waveguide may increase the rigidity and durability of said waveguide, which may facilitate fabrication of said waveguide and/or increase the lifetime of a display device comprising said waveguide. In other embodiments, a waveguide body may have any suitable thickness, for example, a thickness greater than or equal to 0.25 mm, or to 0.27 mm, or to 0.3 mm, or to 0.5 mm and/or less than or equal to 5 mm, or to 2 mm, or to 1 mm.

In the embodiment of FIG. 1, the waveguide body 1100 may be formed of glass, such as high-refractive-index glass, for example, high-refractive-index silicate glass. Generally, a waveguide body of a waveguide comprising, consisting essentially of, or consisting of silicate glass(es) may provide beneficial optical properties to said waveguide and/or further increase the rigidity and durability of said waveguide, which may facilitate fabrication of said waveguide and/or increase the lifetime of a display device comprising said waveguide. In other embodiments, a waveguide body may comprise, consist essentially of, or consist of any suitable optically transparent material(s), for example, glass, such as silicate glass, e.g., fused quartz glass, soda-lime glass, borosilicate glass, lead glass, and/or aluminosilicate glass. In such embodiments, such glass-based material(s) may or may not be high-refractive-index glass(es), i.e., glass(es) having a refractive index greater than 1.5 at a pre-determined visible wavelength. The waveguide body 1100 of the embodiment of FIG. 1 may have a refractive index (n_{B}) of approximately 1.7, 1.9, or 2.0 at a pre-determined visible wavelength, such as 500 nanometers (nm). In other embodiments, a waveguide body may have any suitable refractive index, for example a refractive index greater than or equal to 1.5, or to 1.6, or to 1.7, or to 1.8, or to 1.9 at a pre-determined visible wavelength, such as 400 nm, 500 nm, or 600 nm.

In the embodiment of FIG. 1, the coating 1200 may be formed of organic polymer resist suitable for nanoimprint lithography. In other embodiments, a coating may comprise, consist essentially of, or consist of any suitable optically transparent material(s), for example, organic polymer(s) and, optionally, inorganic filler(s), such as metal oxide nanoparticles.

The coating 1200 of the embodiment of FIG. 1 may have a refractive index (n_{C}) higher than ng at the pre-determined visible wavelength. In other embodiments, a coating may or may not have a refractive index higher than a refractive index of a waveguide body at a pre-determined visible wavelength, such as 400 nm, 500 nm, or 600 nm.

In the embodiment of FIG. 1, n_{C} may be approximately 1.8 at the pre-determined wavelength. In other embodiments, a coating may have any suitable refractive index, for example a refractive index greater than or equal to 1.6, or to 1.7, or to 1.8, at a pre-determined visible wavelength, such as 400 nm, 500 nm, or 600 nm.

The waveguide body 1100 of the embodiment of FIG. 1 is self-supporting and non-foldable. In other embodiments, a waveguide body may or may not be self-supporting and/or non-foldable.

FIGS. 2 to 4 depict three waveguides 1000 according to three different embodiments. The embodiments of FIGS. 2 to 4 may be in accordance with any of the embodiments disclosed with reference to or in conjunction with FIG. 1. Additionally or alternatively, although not explicitly shown in any of FIGS. 2 to 4, any of the embodiments of FIGS. 2 to 4 or any part thereof may generally comprise any features and/or elements of the embodiment of FIG. 1.

Each of the waveguides 1000 of the embodiments of FIGS. 2 to 4 comprises a waveguide body 1100 comprising a first face 1110 as well as a coating 1200 on the first face 1110 comprising an outer surface 1210 facing away from the first face 1110. Each of the first faces 1110 comprises a curved interface region 1111 between a waveguide body 1100 and a coating 1200, and each of the outer surfaces 1210 comprises a curved outer region 1211 opposite an interface region 1111. Each of the outer regions 1211 comprises a patterned region 1212 defined by a surface-relief structure.

In the embodiments of FIGS. 2 to 4, each of the interface regions 1111 has a developable shape. Generally, an interface region of a first face of a waveguide body of a waveguide having a developable shape may facilitate imprinting a surface-relief structure into a coating arranged on said first face. In other embodiments, an interface region may or may not have a developable shape.

Herein, a region or a surface having a “developable shape” may refer to said region or surface being describable as a macroscopically smooth surface with zero Gaussian curvature. Additionally or alternatively, a region or a surface having a developable shape may refer to said region or surface having a shape flattenable onto a plane without distortions. Additionally or alternatively, a region or a surface having a developable shape may refer to said region or surface having a generally cylindrical or conical shape. In particular, developable shape of an interface region of a first face of a waveguide body does not entail that said waveguide body is foldable or is not self-supporting.

Additionally, the interface regions 1111 of the embodiments of FIGS. 3 and 4 have non-inflecting curvatures. Generally, an interface region of a first face of a waveguide body of a waveguide having a non-inflecting curvature may further facilitate imprinting a surface-relief structure into a coating arranged on said first face. In other embodiments, wherein an interface region has a developable shape, said interface region may or may not have a non-inflecting curvature.

As shown in FIGS. 3 and 4, the interface region 1111 of the embodiment of FIG. 3 curves inwards, whereas the interface region 1111 of the embodiment of FIG. 4 curves outwards. In other embodiments, wherein an interface region has a developable shape and a non-inflecting curvature, said interface region may curve inwards or outwards.

In the embodiment of FIG. 4, the interface region 1111 curves cylindrically about an imaginary primary axis 1112. As such, the interface region 1111 has a constant radius of curvature (R) throughout the extent thereof. Generally, an interface region curving cylindrically about an imaginary primary axis may facilitate imprinting a surface-relief structure into a coating arranged on said first face. In other embodiments, an interface region may or may not curve cylindrically about an imaginary primary axis.

In some embodiments, wherein an interface region has a developable shape and a non-inflecting curvature, an interface region may have a maximum radius of curvature (Rₘₐₓ) and a minimum radius of curvature (Rₘᵢₙ) larger than or equal to 0.8, or to 0.85, or to 0.9, or to 0.95 times Rₘₐₓ. Generally, a lower difference between a maximum radius of curvature and a minimum radius of curvature of an interface region may facilitate imprinting a surface-relief structure into a coating arranged on said first face. In other embodiments, wherein an interface region has a developable shape and a non-inflecting curvature, an interface region may have any suitable maximum radius of curvature and any suitable minimum radius of curvature.

In embodiments, wherein an interface region of a first face of a waveguide body of a waveguide has a developable shape and a non-inflecting curvature, said interface region may have any suitable minimum radius of curvature and/or any suitable maximum radius of curvature dictated by intended use of said waveguide. Such intended use may comprise, for example, use in spectacles comprising a see-through display, or in a helmet-mounted display, or in a window of a vehicle. In some embodiments, wherein an interface region of a first face of a waveguide body of a waveguide has a developable shape and a non-inflecting curvature, said interface region may have a minimum radius of curvature greater than or equal to 5 centimeters (cm), or to 8 cm, or to 10 cm and/or a maximum radius of curvature less than or equal to 200 cm, or to 100 cm, or to 50 cm, or to 30 cm.

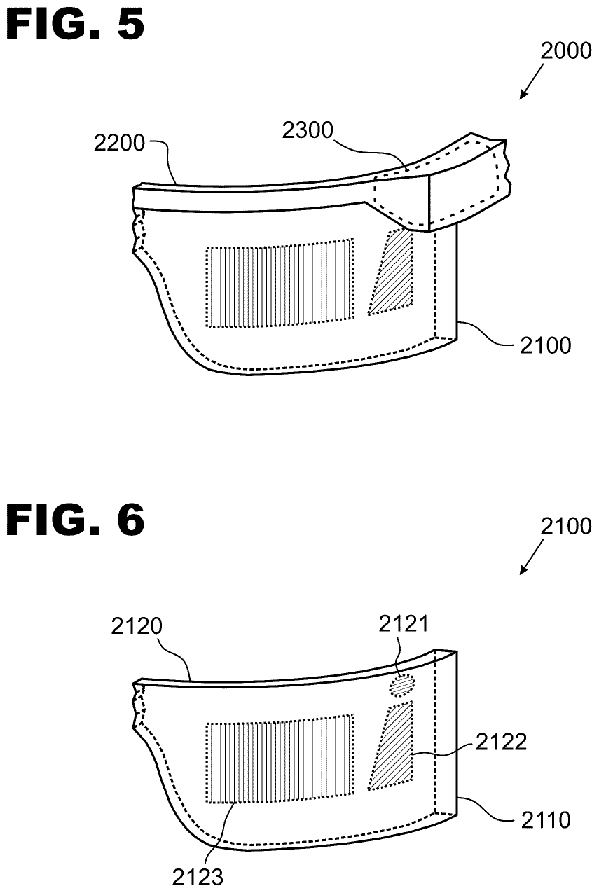

FIG. 5 depicts a partial view of a display device 2000 according an embodiment, and FIG. 6 shows a detailed view of a waveguide 2100 of the display device 2000. The embodiment of FIGS. 5 and 6 may be in accordance with any of the embodiments disclosed with reference to or in conjunction with any of FIGS. 1 to 4. Additionally or alternatively, although not explicitly shown in either of FIGS. 5 and 6, the embodiment of FIGS. 5 and 6 or any part thereof may generally comprise any features and/or elements of any of the embodiments of FIGS. 1 to 4. In particular, the waveguide 2100 of the embodiment of FIGS. 5 and 6 is in accordance with the first aspect discussed above.

In this specification, a “display device” may refer to an operable output device, e.g., electronic device, for visual presentation of images and/or data. A display device may generally comprise any part(s) or element(s) necessary or beneficial for visual presentation of images and/or data, for example, a power unit; an optical engine; a combiner optics unit, such as a waveguide-based combiner optics unit; an eye tracking unit; a head tracking unit; a gesture sensing unit; and/or a depth mapping unit. A display device may or may not be a portable display device, for example, a head-mounted display device, and/or a see-through display device.

Herein, a “head-mounted display device” may refer to a display device configured to be worn on the head, as part of a piece of headgear, and/or on or over the eyes.

Further, a “see-through display device” or “transparent display device” may refer to a display device allowing its user to see the images and/or data shown on the display device as well as to see through the display device.

In the embodiment of FIGS. 5 and 6, the display device 2000 comprises a frame 2200 configured to support the waveguide 2100. In other embodiments, a display device may or may not comprise such frame.

As shown in FIG. 6, the waveguide 2100 comprises a waveguide body 2110 and a coating 2120 on the waveguide body 2110. The coating 2120 comprises a first surface-relief structure 2121, a second surface-relief structure 2122, and a third surface-relief structure 2123.

The first surface-relief structure 2121 comprises a diffractive in-coupling grating for coupling light into the waveguide 2100. The second surface-relief structure 2122 comprises an intermediate pupil-expansion grating configured to receive light from the in-coupling grating and to perform exit pupil expansion by pupil replication along a first direction. The third surface-relief structure 2123 comprises an out-coupling grating configured to receive light from the intermediate pupil-expansion grating, to perform exit pupil expansion by pupil replication along a second direction perpendicular to the first direction, and to couple light out of the waveguide 2100. In other embodiments, a coating may or may not comprise such first surface-relief structure, and/or such second surface-relief structure, and/or such third surface-relief structure.

As shown in FIG. 5, the display device 2000 further comprises an optical engine 2300 configured to direct light into the waveguide 2100 for propagation in the waveguide 2100 by total internal reflection. In other embodiments, a display device may or may not comprise such optical engine.

In the embodiment of FIGS. 5 and 6, the display device 2000 is implemented as a see-through head-mounted display device, more specifically, as spectacles comprising a see-through display. In other embodiments, a display device may be implemented in any suitable manner, for example, as a see-through and/or head-mounted display device.

It is to be understood that the embodiments of the first and second aspects described above may be used in combination with each other. Several of the embodiments may be combined together to form a further embodiment.

Above, mainly structural and material aspects of waveguides and display devices are discussed. In the following, more emphasis will lie on aspects related to methods and apparatuses for forming waveguides. What is said above about the ways of implementation, definitions, details, and advantages related to waveguides and display devices applies, mutatis mutandis, to the methods and apparatus aspects discussed below. The same applies vice versa.

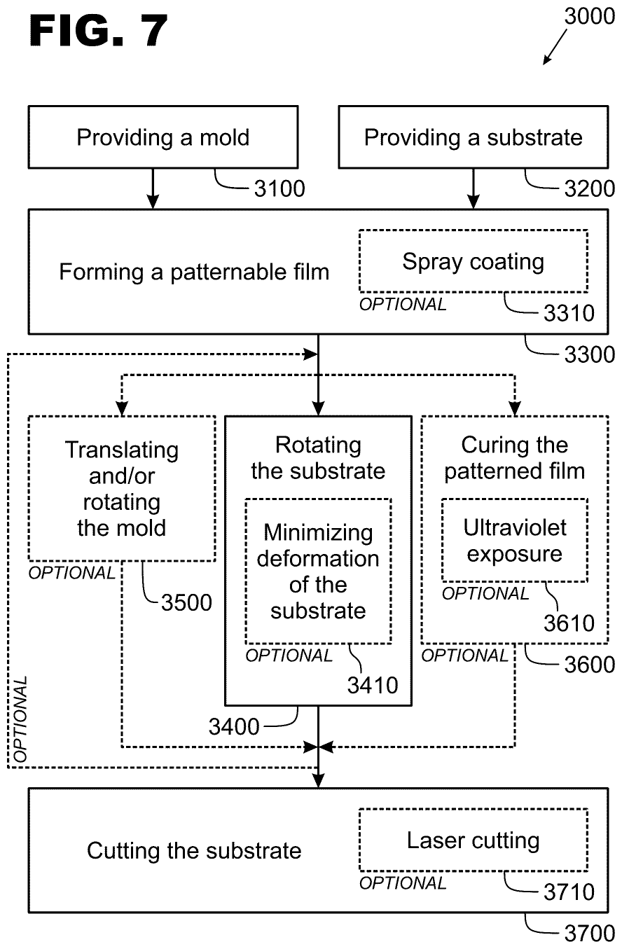

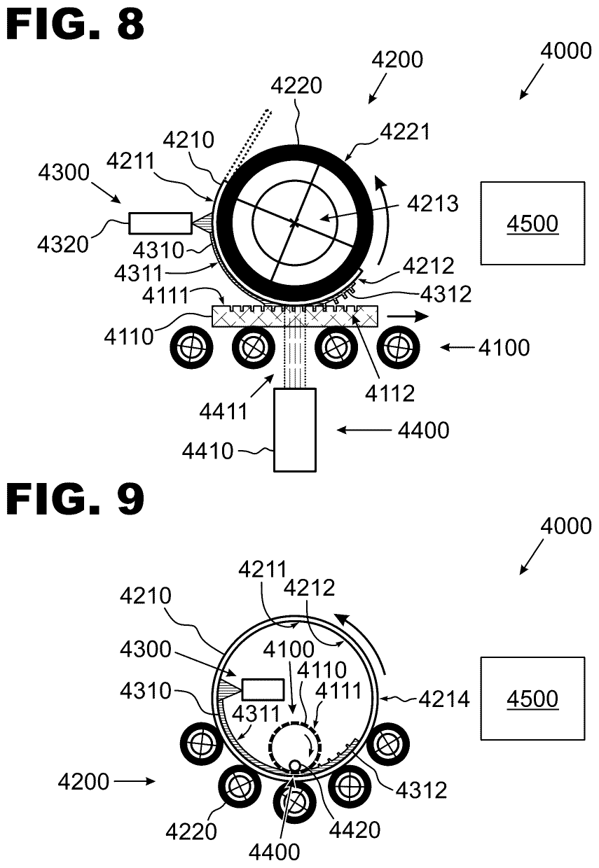

FIG. 7 illustrates a method 3000 for forming a waveguide. In other embodiments, a method for forming a waveguide may be identical, similar, or different to the method 3000 of the embodiment of FIG. 7.

As indicated in FIG. 7 using solid lines, the method 3000 of the embodiment of FIG. 7 comprises the processes of providing a mold 3100 comprising a contact surface patterned with a surface-relief pattern; providing a substrate 3200 comprising a first surface comprising a curved surface region; forming a patternable film 3300 on the first surface, the patternable film comprising an external surface facing away from the surface region; rotating the substrate 3400 such that the external surface rolls over the contact surface to imprint the surface-relief pattern from the contact surface into the patternable film to form a patterned film; and cutting the substrate 3700 to form the waveguide. Generally, a method for forming a waveguide comprising processes corresponding to the processes above may enable forming a waveguide according to the first aspect in a manner suitable for industrial-scale manufacturing.

In this specification, a “process” may refer to a series of one or more steps, leading to an end result. As such, a process may be a single-step or a multi-step process. Additionally, a process may be divisible to a plurality of sub-processes, wherein individual sub-processes of such plurality of sub-processes may or may not share common steps. Herein, a “step” may refer to a measure taken in order to achieve a pre-defined result.

As indicated in FIG. 7 using dashed lines, the process of forming a patternable film 3300 may comprise a spray coating 3310 step. Generally, a process of forming a patternable film comprising a spray coating step may facilitate optimization of said process. In other embodiments, a process of forming a patternable film may or may not comprise a spray coating step. In some embodiments, a process of forming a patternable film may comprise a dip coating step, and/or a spin coating step, and/or a chemical vapor deposition (CVD) polymerization step in addition or as an alternative to a spray coating step.

As indicated in FIG. 7 using dashed lines, the process of rotating the substrate 3400 may optionally comprise minimizing deformation of the substrate 3410. Generally, minimizing deformation of the substrate while rotating the substrate may reduce probability of breaking the substrate when forming a waveguide body therefrom. Additionally or alternatively, minimizing deformation of the substrate while rotating the substrate may improve pattern fidelity of imprinting. In other embodiments, a process of rotating the substrate may or may not comprise minimizing deformation of the substrate. For example, in some embodiments, controlled deformation of a substrate during a process of rotating the substrate may facilitate imprinting a surface-relief pattern into a patternable film arranged onto a substrate not having a bent sheet-like shape or a tubular shape.

In the embodiment of FIG. 7, the process of minimizing deformation of the substrate 3410 may comprise supporting the substrate from a second surface facing away from the first surface. Such supporting may be achieved, for example, by coupling the second surface with a roller comprising an exterior surface having a shape congruent with shape of the second surface.

As once again indicated in FIG. 7 using dashed lines, the method 3000 of the embodiment of FIG. 7 may optionally further comprise translating and/or rotating the mold 3500 during the process of rotating the substrate 3400. Generally, translating and/or rotating the mold while rotating the substrate may reduce the extent to which the substrate must be translated during imprinting in order to maintain suitable imprinting conditions, which may, in turn, facilitate forming a waveguide. In other embodiments, a method for forming a waveguide may or may not comprise translating and/or rotating the mold during a process of rotating the substrate.

Similarly, the method 3000 of the embodiment of FIG. 7 may optionally further comprise curing the patterned film 3600. Generally, a method for forming a waveguide comprising curing the patterned film may increase durability of any surface-relief structure(s) imprinted into a patternable film, which may, in turn increase lifetime of said waveguide. In other embodiments, a method for forming a waveguide may or may not comprise curing the patterned film. For example, in some embodiments, a thermoplastic patternable film may be used as an imprint resist, whereby no curing is necessary to replicate a surface-relief pattern into said patternable film to form a patterned film.

In the embodiment of FIG. 7, the process of curing the patterned film 3600 may optionally comprise an ultraviolet exposure 3610 step for curing the patterned film. In other embodiments, a process of curing the patterned film may or may not comprise an ultraviolet exposure. For example, in some embodiments, a process of curing the patterned film may comprise a heat treatment step and/or a catalytic polymerization step for curing a patterned film in addition to or as an alternative to an ultraviolet exposure step.

As yet again indicated in FIG. 7 using dashed lines, the process of cutting the substrate 3700 may comprise a laser cutting 3710 step. Generally, a process of cutting the substrate comprising a laser cutting step may reduce edge roughness and/or expedite the formation of a waveguide. In other embodiments, a process of cutting the substrate may or may not comprise a laser cutting step. In some embodiments, a process of cutting the substrate may comprise a mechanical sawing step in addition or as an alternative to a laser cutting step. During such mechanical sawing step, a rotating abrasive disc, commonly referred to as a blade, may be used for cutting the substrate. In some embodiments, a process of cutting the substrate may comprise a water jet cutting step and/or a glass cutting step in addition to or as an alternative to any other step(s).

In the embodiment of FIG. 7, the surface region may have a developable shape. Generally, a surface region having a developable shape may facilitate imprinting a surface-relief pattern into a patternable film covering said surface region. In other embodiments, a surface region may or may not have a developable shape. For example, in some embodiments, wherein a surface region has a non-developable, i.e., a doubly curved shape, a mold having a contact surface with a non-developable shape complementary to the shape of said surface region may be used for imprinting.

In particular, in the method 3000 of the embodiment of FIG. 7, the substrate may have a bent sheet-like shape or a tubular shape. In other embodiments, a substrate may have any suitable shape, for example, a bent sheetlike shape or a tubular shape.

Throughout this specification, the term “tubular” is to be interpreted broadly. As such, the term tubular may refer to any elongate and hollow shape, which may have any suitable cross-sectional shape, for example, a curvilinear, e.g., circular, substantially circular, elliptical, or a partly curvilinear cross-sectional shape. Additionally or alternatively, a tubular element may or may not have a constant inner cross-sectional area and/or a constant outer cross-sectional area.

In case the substrate of the embodiment of FIG. 7 has a bent sheet-like shape or a tubular shape, the substrate may have a thickness measured from the surface region, greater than or equal to 0.25 mm, or to 0.27 mm, or to 0.3 mm, or to 0.5 mm and/or less than or equal to 5 mm, or to 2 mm, or to 1 mm. Generally, a higher thickness of a substrate may increase the rigidity and durability of said substrate, which may reduce risk of breaking said substrate when imprinting a surface-relief pattern into a patternable film covering said substrate. In other embodiments, a substrate having a bent sheet-like shape or a tubular shape may have any suitable thickness, for example, a thickness greater than or equal to 0.25 mm, or to 0.27 mm, or to 0.3 mm, or to 0.5 mm and/or less than or equal to 5 mm, or to 2 mm, or to 1 mm.

In case the surface region has a developable shape in the embodiment of FIG. 7, the surface region may further have a non-inflecting curvature. In such case, the surface region may curve either inwards or outwards. Generally, a surface region having a non-inflecting curvature may further facilitate imprinting a surface-relief pattern into a patternable film covering said surface region. In other embodiments, wherein a surface region has a developable shape, said surface region may or may not further have a non-inflecting curvature.

In the embodiment of FIG. 7, the surface region may have a maximum radius of curvature and a minimum radius of curvature larger than or equal to 0.8, or to 0.85, or to 0.9, or to 0.95 times the maximum radius of curvature. Generally, a lower difference between a maximum radius of curvature and a minimum radius of curvature of a surface region may facilitate imprinting a surface-relief pattern into a patternable film covering said surface region. In other embodiments, wherein a surface region has a developable shape and a non-inflecting curvature, said surface region may have any suitable maximum radius of curvature and any suitable minimum radius of curvature, for example, a minimum radius of curvature larger than or equal to 0.8, or to 0.85, or to 0.9, or to 0.95 times a maximum radius of curvature.

In the embodiment of FIG. 7, the substrate may comprise glass, such as silicate glass, e.g., fused quartz glass, soda-lime glass, borosilicate glass, lead glass, and/or aluminosilicate glass. Generally, a substrate comprising, consisting essentially of, or consisting of such material(s) increase the rigidity and durability of said substrate, which may reduce risk of breaking said substrate when imprinting a surface-relief pattern into a patternable film covering said substrate. In other embodiments, a substrate may comprise, consist essentially of, or consist of any suitable optically transparent material(s), for example, glass, such as silicate glass, e.g., fused quartz glass, soda-lime glass, borosilicate glass, lead glass, and/or aluminosilicate glass.

The substrate of the embodiment of FIG. 7 may have a refractive index of approximately 1.7 at a pre-determined visible wavelength, such as 500 nm. In other embodiments, a substrate may have any suitable refractive index, for example a refractive index greater than or equal to 1.5, or to 1.6, or to 1.7, at a pre-determined visible wavelength, such as 400 nm, 500 nm, or 600 nm.

In the embodiment of FIG. 7, the patternable film may be formed of organic polymer resist suitable for nanoimprint lithography. In other embodiments, a patternable film may comprise, consist essentially of, or consist of any suitable optically transparent material(s), for example, organic polymer(s) and, optionally, inorganic filler(s), such as metal oxide nanoparticles.

Following completion of the method 3000 of the embodiment of FIG. 7, the patterned film may have a refractive index higher than the refractive index of the substrate at the pre-determined visible wavelength. In other embodiments, following completion of the method for forming a waveguide, a patterned film may or may not have a refractive index higher than a refractive index of a substrate at a pre-determined visible wavelength, such as 400 nm, 500 nm, or 600 nm.

In the embodiment of FIG. 7, the refractive index of the patterned film may be approximately 1.8 at the predetermined wavelength after completion of the method 3000. In other embodiments, a patterned film may have any suitable refractive index, for example a refractive index greater than or equal to 1.6, or to 1.7, or to 1.8, at a pre-determined visible wavelength, such as 400 nm, 500 nm, or 600 nm.

The substrate of the embodiment of FIG. 7 may be self-supporting and non-foldable. In other embodiments, a substrate may or may not be self-supporting and/or non-foldable.

In some embodiments, a method for forming a waveguide may comprise processes corresponding to the processes of the method 3000 of the embodiment of FIG. 7. In other embodiments, a method for forming a waveguide may comprise processes corresponding to the processes of providing a mold 3100, providing a substrate 3200, forming a patternable film 3300, rotating the substrate 3400, and cutting the substrate 3700 of the method 3000 of the embodiment of FIG. 7. In some of such other embodiments, said method for forming a waveguide may comprise one or more processes corresponding to one or more of the processes of translating and/or rotating the mold 3500 and curing the patterned film 3600 of the method 3000 of the embodiment of FIG. 7.

Generally, steps of a method for forming a waveguide implementing processes corresponding to any of the processes of the method 3000 of the embodiment of FIG. 7 need not be executed in a fixed order. However, steps implementing a process corresponding to one or more of the processes of providing a mold 3100 and providing a substrate 3200 are typically executed prior to steps implementing any process corresponding to one or more of the processes of forming a patternable film 3300, rotating the substrate 3400, translating and/or rotating the mold 3500, curing the patterned film 3600, and cutting the substrate 3700.

A method for forming a waveguide may generally comprise any number of additional processes or steps that are not disclosed herein in connection to the method 3000 of the embodiment of FIG. 7.

FIG. 8 schematically depicts an apparatus 4000 for forming a waveguide in accordance with the first aspect. Although not explicitly shown in FIG. 8, the apparatus 4000 of the embodiment of FIG. 8 may comprise means for carrying out any method in accordance with the third aspect, e.g., the method 3000 of the embodiment of FIG. 7.

Throughout this specification, an “apparatus” may refer to a device suitable for or configured to perform at least one specific process. An apparatus may generally comprise one or more parts, and each of the one or more parts may be classified as belonging to an arrangement of said apparatus.

Herein, an “arrangement” of an apparatus configured to perform a process may refer to a set of one or more parts of said apparatus suitable for or configured to perform at least one specific subprocess of said process. As such, an “apparatus comprising an arrangement” may refer to said apparatus comprising part(s) belonging to said arrangement. Generally, an arrangement may comprise any elements(s), for example, mechanical, electrical, fluidic, and/or optical elements, necessary and/or beneficial for performing its specific subprocess.

In the embodiment of FIG. 8, the apparatus 4000 comprises a mold holder arrangement 4100 configured to hold a mold 4110 comprising a contact surface 4111 patterned with a surface-relief pattern 4112; a substrate holder arrangement 4200 configured to hold a substrate 4210 comprising a first surface 4211 comprising a curved surface region 4212; and a film formation arrangement 4300 configured to form a patternable film 4310 on the first surface 4211. The patternable film 4310 comprises an external surface 4311 facing away from the surface region 4212. As schematically depicted in FIG. 8, the apparatus 4000 further comprises a substrate cutting arrangement 4500 configured to cut the substrate 4210 to form the waveguide. The substrate holder arrangement 4200 of the embodiment of FIG. 8 is configured to rotate the substrate 4210 such that the external surface 4311 rolls over the contact surface 4111 to imprint the surface-relief pattern 4112 from the contact surface 4111 into the patternable film 4310 to form a patterned film 4312.

In the embodiment of FIG. 8, the curved surface region 4212 has a developable shape and a non-inflecting curvature and curves outwards. In other embodiments, a curved surface region may have any suitable shape.

In the embodiment of FIG. 8, the curved surface region 4212 extends throughout the first surface 4211. In other embodiments, a surface region may or may not extend throughout a first surface. For example, as depicted schematically in FIG. 8 using dotted lines, in some embodiments, wherein a substrate has a bent sheetlike shape, said a substrate may comprise a flat portion such that a first surface may comprise a flat region.

The surface region 4212 of the embodiment of FIG. 8 curves cylindrically about an imaginary rotation axis 4213. In FIG. 8, the rotation axis 4213 extends perpendicular to the plane of the drawing and is depicted using a cross symbol. In other embodiments, a surface region may or may not curve cylindrically about a rotation axis.

In the embodiment of FIG. 8, the substrate holder arrangement 4200 is configured to rotate the substrate 4210 about the rotation axis 4213. Generally, a substrate holder arrangement being configured to rotate a substrate about a rotation axis about which a surface region curves cylindrically may facilitate imprinting a surface-relief pattern into a patternable film arranged onto said substrate. Additionally or alternatively, such features may simplify the construction of a substrate holder arrangement suitable for rotating the substrate. In other embodiments, a substrate holder arrangement may or may not be configured to rotate a substrate about a rotation axis about which a surface region curves cylindrically.

The substrate holder arrangement 4200 of the embodiment of FIG. 8 is configured to minimize deformation of the substrate 4210 while rotating the substrate 4210. Generally, a substrate holder arrangement being arranged in such manner may reduce risk of breakage of a substrate when forming a waveguide. In other embodiments, a substrate holder arrangement may or may not be configured to minimize deformation of a substrate while rotating said substrate.

In the embodiment of FIG. 8, the substrate 4210 has a bent sheet-like shape. As such, the substrate 4210 comprises a second surface 4214 facing away from the first surface 4211. In other embodiments, a substrate may or may not have bent sheet-like shape.

In the embodiment of FIG. 8, the substrate holder arrangement 4200 is configured to minimize deformation of the substrate 4210 by being provided with a roller 4220 comprising an exterior surface 4221 having a shape congruent with shape of the second surface 4214. The exterior surface 4221 is configured to be coupled with the second surface 4214, when the apparatus 4000 is in use. In other embodiments, wherein a substrate holder arrangement of an apparatus for forming a waveguide is configured to minimize deformation of a substrate while rotating said substrate, said substrate holder arrangement may be configured to minimize deformation of said substrate by any suitable means, for example, by being provided with a roller comprising an exterior surface having a shape congruent with shape of at least part of a second surface, said exterior surface being configured to be coupled with said at least part of said second surface, when said apparatus is in use.

In the embodiment of FIG. 8, the film formation arrangement 4300 comprises a spray coater 4320. In other embodiments, a film formation arrangement may comprise any part(s) suitable for or beneficial for forming a patternable film, for example, a spray coater. In some embodiments, a film formation arrangement may comprise a dip coater or a CVD reactor in addition to or as an alternative to a spray coater.

In the embodiment of FIG. 8, the apparatus 4000 further comprises a film curing arrangement 4400 configured to cure the patterned film 4312. In other embodiments, an apparatus for forming a waveguide may or may not comprise such film curing arrangement.

The film curing arrangement 4400 of the embodiment of FIG. 8 is configured to expose the patterned film 4312 to ultraviolet radiation 4411. To such end, the film curing arrangement 4400 comprises an ultraviolet radiation source 4410. In other embodiments, a film curing arrangement may or may not be configured to expose a patterned film to ultraviolet radiation to cure said patterned film. In embodiments, wherein a film curing arrangement is configured to expose a patterned film to ultraviolet radiation to cure said patterned film, said film curing arrangement may comprise any part(s) suitable for or beneficial for exposing said patterned film to ultraviolet radiation, for example, an ultraviolet radiation source.

In the embodiment of FIG. 8, the mold holder arrangement 4100 is configured to translate the mold 4110, while the substrate holder arrangement 4200 rotates the substrate 4210. In other embodiments, a mold holder arrangement may be configured to hold a mold in any suitable manner while a substrate holder arrangement rotates a substrate. For example, in some embodiments, a mold holder arrangement may be configured to translate and/or rotate a mold, while a substrate holder arrangement rotates a substrate. In some embodiments, a mold holder arrangement may be configured to hold a mold stationary while a substrate holder arrangement rotates a substrate.

In the embodiment of FIG. 8, the mold 4110 has a flat shape. In other embodiments, wherein a curved surface region curves outwards, a mold holder arrangement may be configured to hold a mold of any suitable shape, for example, a flat shape or a tubular shape.

In the embodiment of FIG. 8, the substrate holder arrangement 4200 may be configured to repeat the process of rotating the substrate 4210 before the substrate cutting arrangement 4500 cuts the substrate 4210 to form the waveguide. In such case, the process of rotating the substrate 4210 may be repeated to form a plurality of replicas of the surface-relief pattern 4112, wherein the plurality of replicas may be arranged, for example, in an array extending circumferentially around the rotation axis 4213 and/or longitudinally parallel to the rotation axis 4213. In other embodiments, a substrate holder arrangement may or may not be configured to repeat a process of rotating the substrate before a substrate cutting arrangement cuts said substrate to form a waveguide.

FIG. 9 schematically depicts another apparatus 4000 for forming a waveguide in accordance with the first aspect. Although not explicitly shown in FIG. 9, the apparatus 4000 of the embodiment of FIG. 9 may comprise means for carrying out various methods in accordance with the third aspect.

In the embodiment of FIG. 9, the apparatus 4000 comprises a mold holder arrangement 4100 configured to hold a mold 4110 comprising a contact surface 4111 patterned with a surface-relief pattern; a substrate holder arrangement 4200 configured to hold a substrate 4210 comprising a first surface 4211, which comprises a curved surface region 4212, and a second surface 4214 opposite the first surface 4211; and a film formation arrangement 4300 configured to form onto the first surface 4211 a patternable film 4310 with an external surface 4311 facing away from the surface region 4212. As schematically depicted in FIG. 9, the apparatus 4000 further comprises a substrate cutting arrangement 4500 configured to cut the substrate 4210 to form the waveguide. The substrate holder arrangement 4200 of the embodiment of FIG. 9 is configured to rotate the substrate 4210 such that the patternable film 4310 rolls over the contact surface 4111 to imprint the surface-relief pattern 4112 from the contact surface 4111 into the patternable film 4310 to form a patterned film 4312.

The substrate 4210 of the embodiment of FIG. 9 has a tubular shape and a circular cross section. In other embodiments, a substrate may or may not have such shape.

In the embodiment of FIG. 9, the substrate holder arrangement 4200 is configured to minimize deformation of the substrate 4210 while rotating the substrate 4210 by being provided with a plurality of rollers, each roller 4220 of the plurality of rollers comprising an exterior surface 4221 configured to be coupled with the second surface 4214, when the apparatus 4000 is in use. In other embodiments, a substrate holder arrangement of an apparatus for forming a waveguide may or may not be configured to minimize deformation of a substrate while rotating said substrate by being provided with a plurality of rollers, each roller of said plurality of rollers comprising an exterior surface configured to be coupled with a second surface, when said apparatus is in use.

In the embodiment of FIG. 9, the mold holder arrangement 4100 is configured to rotate the mold 4110, while the substrate holder arrangement 4200 rotates the substrate 4210. In other embodiments, a mold holder arrangement may or may not be configured to rotate a mold. In the embodiment of FIG. 9, the apparatus 4000 comprises a film curing arrangement 4400 configured to heat the patterned film 4312 to cure the patterned film 4312. To such end, the film curing arrangement 4400 comprises a heated roller 4420 for heating the mold 4110. In other embodiments, a film curing arrangement may or may not be configured heat a patterned film to cure said patterned film. In embodiments, wherein a film curing arrangement is configured to cure a patterned film by heating said patterned film, said film curing arrangement may comprise any part(s) suitable for or beneficial for heating said patterned film, for example, a heated roller. In some embodiments, a film curing arrangement may be configured to heat a patterned film and to expose said patterned film to ultraviolet radiation to cure said patterned film.

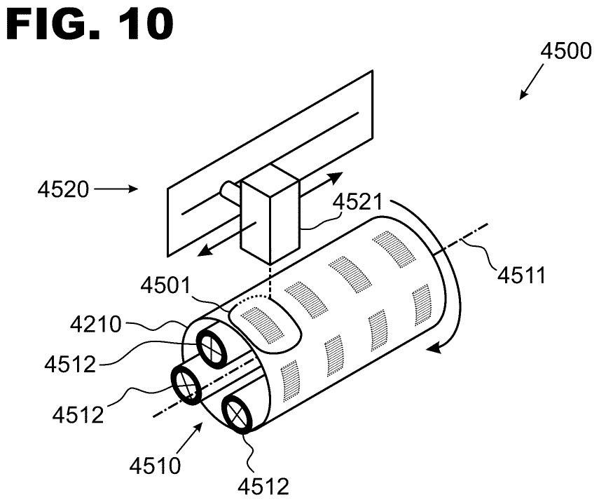

FIG. 10 depicts a substrate cutting arrangement 4500 of an apparatus for forming a waveguide in accordance with the fourth aspect. The apparatus of the embodiment of FIG. 10 may, for example, comprise one or more features disclosed with reference to or in conjunction with one or both of FIGS. 8 and 9.

The substrate cutting arrangement 4500 of the embodiment of FIG. 10 is configured to cut a substrate 4210 to form the waveguide. In FIG. 10, a groove 4501 cut by the substrate cutting arrangement 4500 is depicted using a solid line, whereas an un-cut part of a contour of the waveguide is depicted using a dotted line.

In the embodiment of FIG. 10, the substrate cutting arrangement 4500 comprises a rotation tool 4510 for rotating the substrate 4210 along a cutter rotation axis 4511 when cutting the substrate 4210 and a cutting tool 4520 comprising a cutting head 4521 configured to move parallel to the cutter rotation axis 4511 for machining the substrate 4210. In other embodiments, a substrate cutting arrangement may or may not comprises such rotation tool and such cutting tool.

The rotation tool 4510 of the embodiment of FIG. 10 comprises plurality of cutter rollers. The cutter rollers 4512 of the plurality of cutter rollers are configured to be coupled to the substrate 4210 for rotating the substrate 4210. In other embodiments, a substrate cutting arrangement may or may not comprise such plurality of cutter rollers. For example, in some embodiments, wherein a substrate cutting arrangement comprises a rotation tool for rotating a substrate when cutting said substrate, said substrate cutting arrangement may comprise one or more robotic arms for rotating the substrate.

In the embodiment of FIG. 10, the cutting head 4521 of the cutting tool 4520 of the embodiment of FIG. 10 is implemented as a laser cutting head. The cutting head 4521 may more specifically be implemented, for example, as an ultrashort pulse laser cutting head, i.e., as a laser cutting head employing laser pulses having pulse durations less than or equal to 1000 nanoseconds (ns), or to 100 ns, or to 10 ns, or to 1 ns. In other embodiments, a cutting head of a cutting tool may or may not be implemented as a laser cutting head, e.g., an ultrashort pulse laser cutting head.

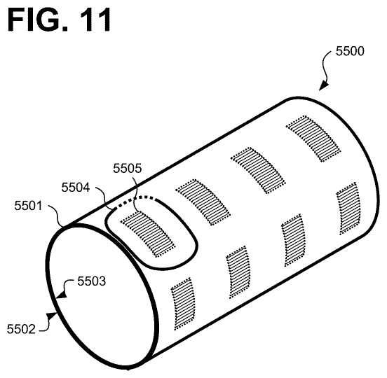

FIG. 11 depicts a substrate 5500. The substrate 5500 can be formed into a plurality of waveguides using, for example, the substrate cutting arrangement 4500 of FIG. 10.

The substrate 5500 may be obtained by, for example, performing all steps of the method 3000 other than the cutting the substrate 3700 to form the waveguide.

Any disclosure herein in relation to the waveguide 1000 and/or to the features/components of the waveguide 1000 may apply to the substrate 5500 and/or to the features/components of the substrate 5500.

It is obvious to a person skilled in the art that with the advancement of technology, the basic idea of the invention may be implemented in various ways. The invention and its embodiments are thus not limited to the examples described above, instead they may vary within the scope of the claims.

It will be understood that any benefits and advantages described above may relate to one embodiment or may relate to several embodiments. The embodiments are not limited to those that solve any or all of the stated problems or those that have any or all of the stated benefits and advantages.

The term “comprising” is used in this specification to mean including the feature(s) or act(s) followed thereafter, without excluding the presence of one or more additional features or acts. It will further be understood that reference to ‘an’ item refers to one or more of those items.

### REFERENCE SIGNS

T thickness of a waveguide body
T radius of curvature
Rₘₐₓ maximum radius of curvature
Rₘᵢₙ minimum radius of curvature
n_{B} refractive index of a waveguide body
n_{C} refractive index of a coating
1000 waveguide
1001 light
1100 waveguide body
1110 first face
1111 interface region
1112 primary axis
1120 second face
1200 coating
1210 outer surface
1211 outer region
1212 patterned region
1220 surface-relief structure
1220 inner surface
2000 display device
2100 waveguide
2110 waveguide body
2120 coating
2121 first surface-relief structure
2122 second surface-relief structure
2123 third surface-relief structure
2200 frame
2300 optical engine
3000 method
3100 providing a mold
3200 providing a substrate
3300 forming a patternable film
3310 spray coating
3400 rotating the substrate
3410 minimizing deformation of the substrate
3500 translating and/or rotating the mold
3600 curing the patterned film
3610 ultraviolet exposure
3700 cutting the substrate 2121 first surface-relief
3710 laser cutting
4000 apparatus
4001 waveguide
4100 mold holder arrangement
4110 mold
4411 ultraviolet radiation
4111 contact surface
4112 surface-relief pattern
4200 substrate holder arrangement
4210 substrate
4211 first surface
4212 surface region
4213 rotation axis
4214 second surface
4220 roller
4221 exterior surface
4300 film formation arrangement
4310 patternable film
4311 external surface
4312 patterned film
4320 spray coater
4400 film curing arrangement
4410 ultraviolet radiation source
4411 ultraviolet radiation
4420 heated roller
4500 substrate cutting arrangement
4501 groove
4510 rotation tool
4511 cutter rotation axis
4512 cutter roller
4520 cutting tool
4521 cutting head
5550 substrate
5501 substrate body
5502 first face
5503 second face
5504 patterned region
5505 surface relief structure

1. A method (3000) for forming a waveguide, the method (3000) comprising:
providing a mold (3100) comprising a contact surface patterned with a surface-relief pattern;
providing a substrate (3200) comprising a first surface comprising a curved surface region, wherein the substrate is rigid;
forming a patternable film (3300) on the first surface, the patternable film comprising an external surface facing away from the surface region;
rotating the substrate (3400) such that the external surface rolls over the contact surface to imprint the surface-relief pattern from the contact surface into the patternable film to form a patterned film; and
cutting the substrate (3700) to form the waveguide.

2. A method (3000) according to claim 1, wherein the process of rotating the substrate (3400) comprises minimizing deformation of the substrate (3410).

3. A method (3000) according to claim 1 or 2, wherein the method comprises:
translating and/or rotating the mold (3500) during the process of rotating the substrate (3400).

4. A method (3000) according to any of claims 1 to 3, wherein the method (3000) comprises:
curing the patterned film (3600).

5. A method (3000) according to any of claims 1 to 4, wherein the method comprises:
repeating the process of rotating the substrate (3400) before cutting the substrate (3700).

6. A method (3000) according to any of claims 1 to 5, wherein the waveguide is a waveguide (1000) in accordance with any of claims 1 to 8.

7. A method (100) according to any of claims 1 to 6, wherein the substrate has a bent sheet-like shape or a tubular shape.

8. A substrate (5500) having bent sheet-like shape or a tubular shape comprising:
a substrate body (5501) comprising a first face (5502) and a second face (5503) opposite the first face (5502);
a coating on the first face (5502), the coating comprising an outer surface facing away from the first face (5502);
wherein the first face (5502) comprises a curved interface region between the substrate body (5501) and the coating, the outer surface comprising a curved outer region opposite the interface region; and
the outer region comprises a plurality of patterned regions (5504), the coating comprising on the outer surface a plurality of surface-relief structures (5505) defining the plurality of patterned regions (5504).

9. An apparatus (4000) for forming a waveguide (4001), the apparatus (4000) comprising:
a mold holder arrangement (4100) configured to hold a mold (4110) comprising a contact surface (4111) patterned with a surface-relief pattern (4112);
a substrate holder arrangement (4200) configured to hold a substrate (4210) comprising a first surface (4211) comprising a curved surface region (4212);
a film formation arrangement (4300) configured to form a patternable film (4310) on the first surface (4211), the patternable film (4310) comprising an external surface (4311) facing away from the surface region (4212); and
a substrate cutting arrangement (4500) configured to cut the substrate (4210) to form the waveguide;
wherein the substrate holder arrangement (4200) is configured to rotate the substrate (4210) such that the external surface (4311) rolls over the contact surface (4111) to imprint the surface-relief pattern (4112) from the contact surface (4111) into the patternable film (4310) to form a patterned film (4312).

10. An apparatus (4000) according to claim 9 comprising means adapted to carry out a method (3000) in accordance with any of claims 1 to 7.

11. A waveguide (1000) configured to propagate light (1001) coupled into the waveguide (1000) by total internal reflection, the waveguide (1000) comprising:
a waveguide body (1100) comprising a first face (1110) and a second face (1120) opposite the first face (1110); and
a coating (1200) on the first face (1110), the coating (1200) comprising an outer surface (1210) facing away from the first face (1110);
wherein the first face (1110) comprises a curved interface region (1111) between the waveguide body (1100) and the coating (1200), the outer surface (1210) comprising a curved outer region (1211) opposite the interface region (1111); and
the outer region (1211) comprises a patterned region (1212), the coating (1200) comprising on the outer surface (1210) a surface-relief structure (1220) defining the patterned region (1212), wherein the waveguide is obtained by a method according to any of claims 1-6.

12. A waveguide (1000) according to claim 11, wherein the surface-relief structure (1220) comprises a diffractive optical element.

13. A waveguide (1000) according to claim 11 or 12, wherein the waveguide body (1100) has a thickness, T, measured from the interface region (1111) to the second face (1120), greater than or equal to 0.25 mm, or to 0.27 mm, or to 0.3 mm, or to 0.5 mm and/or less than or equal to 5 mm, or to 2 mm, or to 1 mm.

14. A waveguide (1000) according to any of claims 11 to 13, wherein the waveguide body (1100) comprises glass, such as silicate glass, e.g., fused quartz glass, soda-lime glass, borosilicate glass, lead glass, and/or aluminosilicate glass.

15. A waveguide (1000) according to any of claims 11 to 14, wherein the interface region (1111) has a developable shape.

16. A waveguide (1000) according to claim 15, wherein the interface region (1111) has a non-inflecting curvature.

17. A waveguide (1000) according to claim 15, wherein the interface region (1111) curves inwards or outwards.

18. A waveguide (1000) according to claim 16 or 17, wherein the interface region (1111) has a maximum radius of curvature, Rₘₐₓ, and a minimum radius of curvature, Rₘᵢₙ, larger than or equal to 0.8, or to 0.85, or to 0.9, or to 0.95 times the maximum radius of curvature, Rₘₐₓ.

19. A display device (2000) comprising a waveguide (2100) in accordance with any of claims 11 to 18.

20. A display device (2000) according to claim 19 implemented as a see-through display device.

21. A display device (2000) according to claim 19 or 20 implemented as a head-mounted display device.
